(19) United States
(12) Patent Application Publication
(10) Pub. No.: US 2007/0122787 A1
(43) Pub. Date: May 31, 2007

(54) METHOD AND APPARATUS FOR STIMULATING A RESPONSE

(76) Inventors: Gregg L. Pembleton, Maple Shade, NJ (US); Mary V. Miller, Maple Shade, NJ (US)

Correspondence Address: RAYMOND R. MOSER JR., ESQ.;MOSER IP LAW GROUP, 1040 BROAD STREET, 2ND FLOOR, SHREWSBURY, NJ, 07702, US

(21) Appl. No.: 11/550,758

(22) Filed: Oct. 18, 2006

Related U.S. Application Data
(60) Provisional application No. 60/596,748, filed on Oct. 18, 2005.

(51) Int. Cl. G09B 19/00

(52) U.S. Cl. 434/322; 434/236

(57) ABSTRACT

A method and apparatus of the present invention include a three-dimensional object, wherein the three-dimensional object includes a plurality of segments, and a plurality of stimuli, wherein at least one stimulus is applied to at least one segment of the plurality of segments. The method comprises providing a three-dimensional object, wherein the three-dimensional object comprises a plurality of segments and a plurality of stimuli, wherein at least one stimulus is applied to at least one segment, transferring the three-dimensional object between a plurality of persons, wherein at least one person of the plurality stops transferring at a specific moment, holding the three-dimensional object, and responding to the at least one stimulus.

### CROSS-REFERENCE TO RELATED APPLICATIONS

This application claims the benefit of U.S. Provisional Patent Application Ser. No. 60/596,748, filed on Oct. 18, 2006, of which is incorporated herein by reference in its entirety.

### BACKGROUND

1. Field of the Invention

Embodiments of the present invention generally relate to an apparatus comprising a three-dimensional object covered with a plurality of stimuli, wherein the stimuli relate to a category of topics or subjects, and a method of using the object.

2. Description of the Related Art

Teachers and evaluators of persons with learning disabilities, emotional disturbance, and/or communication impairments, such as, for example, autism, continually need new, innovative methods and materials to maintain the attention of a person with a learning disability to facilitate learning by that person. Often the focus of such teaching is three-fold: expanding receptive and expressive vocabulary skills, promoting efficient word finding abilities, and organizing and analyzing ideas into effective verbal expression. Thus, there is a need for an innovative method of teaching of persons with learning disabilities, emotional disturbances, and/or communication impairments.

### SUMMARY

An embodiment of the present invention includes an apparatus, comprising a three-dimensional object, wherein the three-dimensional object includes a plurality of segments, and a plurality of stimuli, wherein at least one stimulus is applied to at least one segment of the plurality of segments.

Another embodiment of the present invention includes a method, comprising providing a three-dimensional object, wherein the three-dimensional object comprises a plurality of segments and a plurality of stimuli, wherein at least one stimulus is applied to at least one segment, transferring the three-dimensional object between a plurality of persons, wherein at least one person of the plurality stops transferring at a specific moment, holding the three-dimensional object, and responding to the at least one stimulus.

### BRIEF DESCRIPTION OF THE DRAWINGS

So the manner in which the above recited features of the present invention may be understood in more detail, a more particular description of the embodiments of the present invention, briefly summarized above, may be had by reference to embodiments, some of which are illustrated in the appended drawings. It is to be noted, however, the appended drawings illustrate only typical embodiments of the present invention and are therefore not to be considered limiting of its scope, for the present invention may admit to other equally effective embodiments, in which:

FIG. 1 is perspective view of an apparatus, in accordance with an embodiment of the present invention;

FIG. 2 presents a method of using the apparatus of FIG. 1, in accordance with an embodiment of the present invention.

### DETAILED DESCRIPTION

Embodiments of the present invention include an apparatus comprising a three-dimensional shape covered with a plurality of stimuli.

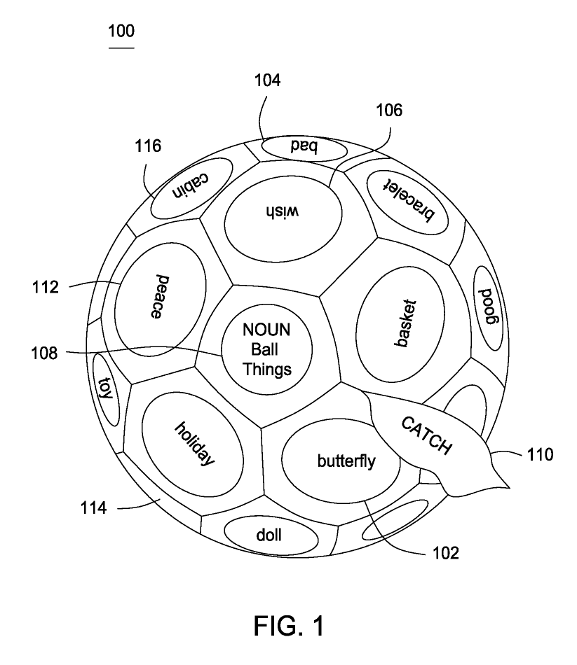

FIG. 1 presents an apparatus 100 comprising a plurality of segments 102 and a plurality of stimuli 104, in accordance with an embodiment of the present invention. The apparatus 100 may comprise any shaped three-dimensional object, including, but not limited to, a three-dimensional polygonal object with a plurality of segments. The apparatus 100 may be made of any material or combination of materials, such as polymeric materials, rubber, plastic, and the like. Embodiments of the present invention include three-dimensional objects, such as a sphere, a cube, a pyramid, a polyhedron, an icosahedron, a truncated icosahedron, and the like. In FIG. 1, the apparatus 100 is a truncated icosahedron with thirty-two segments 102 comprising twenty hexagonal segments 116 and twelve pentagonal segments 114.

The plurality of stimuli 104 may be applied to the plurality of segments 102, wherein each segment 102 is substantially flat. The plurality of stimuli 104 may be applied using a permanent adhesive, a reusable adhesive, VELCRO, and the like. In another embodiment of the present invention, an apparatus 100 may have a plurality of stimuli 104 embossed on a plurality of segments 102. In yet another embodiment of the present invention, an apparatus 100 may have a plurality of stimuli 104 permanently printed onto a plurality of segments 102. In another embodiment of the present invention, an apparatus 100 may have a plurality of segments 102 and a plurality of stimuli 104, where one or more stimuli 104 are embossed onto each segment 102. In yet another embodiment of the present invention, an apparatus 100 comprises a plurality of segments 102, wherein the plurality of segments are made of an erasable printing material, such that a plurality of stimuli 104 may be written or drawn onto the plurality of segments 102, and then erased at a later time to apply a different plurality of stimuli.

As shown in FIG. 1, the plurality of stimuli 104 may include a group of words, such as, for example, nouns, verbs, adjectives, adverbs, and the like, to be used as a learning tool, for example, in an environmental environment. The plurality of stimuli 104 may include any group of text or graphics, such as, for example, words, such as word 106 in FIG. 1, letters, actions, names, pictures, colors, numbers, shapes, commercial brand names, and the like. An embodiment of the present invention includes an apparatus 100 with a stimulus 108 that identifies the category of the plurality of stimuli 104 applied to the apparatus 100.

The apparatus 100 also may include at least one flap 110, wherein the flap 110 is attached to the apparatus 100 at an edge 112 of one or more of the segments 102. In FIG. 1, the flap 110 identifies the apparatus 100 by listing the number of segments 102 and the intended use of the apparatus 100, such as to toss and “catch” the apparatus 100. In another embodiment, an apparatus 100 comprising a plurality of segments 102 and a plurality of stimuli 104 includes a plurality of flaps 110, where each flap 110 substantially covers a stimulus 104 applied to each segment 102. A first side of the flap 110 may adhere to an associated segment 102, where an associated segment is a segment 102 connected to the flap 110 along an edge 112 of the segment 102. A second side of the flap 110 facing the associated segment 102 may comprise an interrogatory stimulus that poses a question, where the interrogatory stimulus is related to a stimulus 104 applied to the associated segment 102, such that the stimulus 104 includes an answer to the interrogatory stimulus. The interrogatory stimulus may include a verbal question, a picture, or a combination of both.

The apparatus 100 may be designed to be any size, with any number of segments 102 and any number of stimuli 104. For example, an embodiment of the present invention may include an apparatus 100 with about 6 stimuli 104 for use as a learning apparatus for young children. In another embodiment of the present invention, an apparatus 100 with about 64 stimuli may be used as a learning tool for older children. One of ordinary skill in the art would readily recognize that the scope of the invention encompasses embodiments with varying numbers of stimuli.

An embodiment of the present invention includes an apparatus 100 in the shape of a three-dimensional polyhedron with a plurality of segments 102 and a plurality of stimuli 104, wherein the polyhedron is a size between about 4.0 inches to about 6.0 inches in diameter. The apparatus 100 of this embodiment may be used for transferring between a plurality of children. Another embodiment of the present invention includes an apparatus 100 comprising a three-dimensional polyhedron that is a size about 2.0 feet to about 4.0 feet in diameter. The apparatus of this embodiment may be used for displaying in a place of business, such as a restaurant, where each stimulus is related to an article of business. For example, an apparatus for a restaurant may be covered with a plurality of stimuli, wherein each stimulus is a particular item on the restaurant's menu. Another embodiment of the present invention includes an apparatus 100 sized substantially similar to a hot-air balloon, wherein the apparatus 100 comprises a plurality of segments 102 and a plurality of stimuli 104 applied to the segments. The apparatus of this embodiment may be used for promotional purposes, such as, for example, at a car dealership, where the stimuli comprise different makes and models of automobiles. One of ordinary skill in the art would readily recognize that the scope of the invention is not limited to the embodiments disclosed, but may encompass other embodiments where the apparatus may be used.

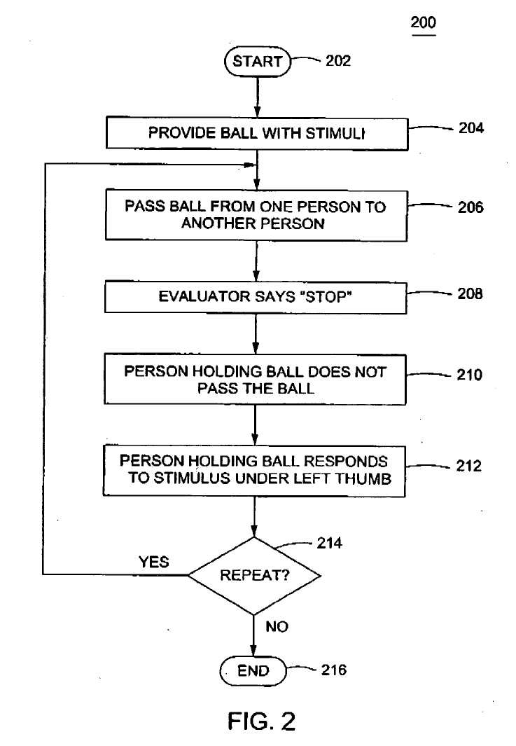

A method of using the apparatus 100 is described in FIG. 2. The apparatus 100 may be used in an educational environment to teach students words. A method 200 begins at step 202 and proceeds to step 204 where an individual, such as an evaluator of the student or group of students, provides the apparatus 100, herein referred to as a “ball,” to the student or group of students.

In step 206, the evaluator may transfer the ball 100 between a number of persons, such as the group of students, wherein transferring the ball 100 includes, but is not limited to, passing, tossing, rolling, kicking, and the like, or any combination thereof. The group of students transfers the ball 100 between themselves until the evaluator says “Stop,” in step 208. An aspect of the embodiment includes the group of persons transferring the ball 100 for a predetermined number of times before the evaluator says “Stop” to halt the transfer. Another embodiment of the present invention includes a method of transferring the ball 100 between a group of persons while setting a timing device, such as an hourglass device, or a stopwatch, for example, wherein the timing device runs continuously during the transfer of the ball 100 until the timing device is halted at a specific moment.

In step 210, the student holding the ball 100 stops transferring the ball. In step 212, the student holding the ball 100 then responds to the stimulus 104 placed in a predetermined position relative to the student, such as under his or her right thumb. At step 212, the student responds to the stimulus 104 by articulating the word on the particular segment 102 under his or her right thumb. At step 214, the student may choose to either continue transferring the ball 100 to repeat the method 200, or to end the method 200 at step 216. Instructions for using the apparatus 100 may be included with the apparatus 100, such as an instructional booklet or pamphlet. The method 200 may be used to develop a person's verbal skills, for example, with autistic children, who may have difficulty speaking. Another embodiment of the present invention includes a method 200 of using an apparatus 100, wherein a person or student must use the word under his or her finger in a sentence.

In another embodiment of the present invention, a method of using the apparatus 100 includes transferring the apparatus 100 between an evaluator and one student. In yet another embodiment of the present invention, a method of using the apparatus 100 includes the evaluator using a visual command to stop the transfer of the apparatus 100, for example, between students with hearing problems. The student holding the apparatus 100 then may respond to the stimulus 106 under any finger he or she chooses, such as, for example, his or her left thumb.

In yet another embodiment of the present invention, an apparatus 100 may be transferred between a plurality of persons while music is playing. When a break in the music occurs, the person holding the apparatus 100 may respond to a stimulus located in a predetermined position relative to the person, such as beneath the person's left or right thumb.

In an embodiment of the present invention, an apparatus 100 may be used to promote a business a specific retailer. For example, an apparatus 100 may have a plurality of segments 102 and a plurality of stimuli 104, wherein each segment has a stimulus applied that identifies a specific candy or candy bar, for example, HERSHEY'S KISSES, made by The Hershey Company. A method may include a plurality of persons transferring the apparatus 100 between one another and identifying the specific candy item when a person is left holding the apparatus 100.

Another embodiment of the present invention includes an apparatus 100 with a plurality of segments 102 and a plurality of stimuli 104, wherein the plurality of stimuli 104 include facts and pictures of a vacation destination to assist vacationers in determining where to visit during their vacation, or to be purchased as a souvenir of their vacation.

In another embodiment of the present invention, an apparatus 100 may comprise a three-dimensional shape with a plurality of segments 102 and a plurality of stimuli 104, where each stimulus 104 is applied to each of the segments and each stimulus 104 comprises an action to be performed, for example, “Hop up and down ten times,” or “find an item that begins with ‘M’” for a learning apparatus 100. An embodiment of the present invention includes a method 200 of transferring an apparatus 100 between a plurality of persons while listening to music. When a break in the music occurs, the person holding the apparatus 100 must perform the action on the stimulus under at least one of the person's fingers. This method 200 is useful in a game setting, such as in a bar or nightclub, for example.

Another embodiment of the present invention includes a virtual apparatus 100 comprising a plurality of segments 102 and a plurality of stimuli 104, using a computer with a central processing unit, support circuits, and a computer-readable memory. The computer-readable storage medium may comprise computer code including modules to provide the virtual apparatus 100. The virtual apparatus 100 may have any number of segments 102 and any number of stimuli 106, and any category of stimuli 104 that may be modified by one or more users of the virtual apparatus 100. A method of using the visual apparatus 100 includes a user clicking a computer softkey or hardkey to set the virtual apparatus 100 into motion, such as, for example, a spinning motion, a bouncing and spinning motion, and the like. At a random moment, the user clicks on a hard key or softkey to halt the motion of the virtual apparatus 100. The user then may select a stimulus to respond to, using a hardkey or softkey, or the user may be prompted by the computer code to respond to a predetermined stimulus. Methods of using the virtual apparatus include, but are not limited to, using the virtual apparatus 100 as a learning device, or as a gaming device by the user, including an online gaming device to be utilized by multiple users.

The following example shows by way of illustration, and not by way of limitation, the practice of embodiments of this invention.

### EXAMPLE 1

In this example, a truncated icosahedron with a plurality of stimuli of category names was manufactured for a group of autistic children. The children were permitted the students to transfer, pass, roll or toss the ball as appropriate to each other. The evaluator would then randomly say, “Stop. Look under your right thumb.” The child holding the icosahedron then would read aloud the category name and state a predetermined number of items that fall within that category. The children displayed improved learning behaviors students including an increased alertness and more focused attention span. Variations on the number, type and speed of responses were utilized and found equally effective for stimulating improved learning behaviors including less disruptions, more focus on each other, and better recall of answers presented. The children identified this activity as play even though more learning occurred then during a traditional academic lesson. The use of a plurality of stimuli applied to a plurality of segments on an apparatus provides for improved identification of which stimulus to respond to.

Exemplary embodiments of an apparatus with a plurality of segments and a plurality of stimuli to be used in an educational environment include categories of stimuli that include, but are not limited to, English or foreign language stimuli, such as, parts of speech, sentence formation, grammatical formulation, vocabulary, reading skills, and speech and pronunciation, science and math stimuli, such as, numbers, equations, formulas, facts and concepts, symbols, and abbreviations, and history stimuli, such as, historical facts and dates, geography, world leaders, states and countries, flags, landmarks, and other historical stimuli. Apparatuses for use in teaching persons with special needs, such as learning disabilities, dyslexia, memory impairments such as Alzheimer's disease patients, hearing impairments, sight impairments, speech impairments, emotional disturbances, and the like may include a plurality of stimuli including, but not limited to, Braille stimuli, visual, and/or tactile stimuli, such as emotions and feelings stimuli, pictorial stimuli, and the like, audible stimuli, such as stimuli that “speaks,” and electronic and/or illuminated stimuli, for example, to assist in the teaching of a person with visual impairment. Other embodiments include an apparatus comprising a plurality of segments and a plurality of stimuli, wherein the plurality of stimuli include therapeutic categories, such as, for example, physical therapy, emotional therapy, cognitive therapy, and the like.

While the foregoing is directed to embodiments of the present invention, other and further embodiments of the present invention may be devised without departing from the basic scope thereof, where the scope thereof is determined by the following claims.

We claim:

1. An apparatus, comprising:
a three-dimensional object, wherein the three-dimensional object includes a plurality of segments; and
a plurality of stimuli, wherein at least one stimulus is applied to at least one segment of the plurality of segments.

2. The apparatus of claim 1, wherein the plurality of stimuli further comprises at least one of a word, letter, action, name, question, picture, color, number, shape, commercial brand name, menu item, and any combination thereof.

3. The apparatus of claim 1, wherein the three-dimensional object is one of a sphere, a cube, a pyramid, a polyhedron, an icosahedron, and a truncated icosahedron.

4. The apparatus of claim 1, further comprising at least one flap, wherein an edge of the at least one flap is affixed to an edge of an associated segment of the plurality of segments.

5. The apparatus of claim 4, wherein a first side of the at least one flap adheres to the associated segment using a reusable adhesive, such that the associated segment is substantially covered by the first side of the at least one flap.

6. The apparatus of claim 5, wherein a second side of the at least one flap has an interrogatory stimulus applied, wherein the interrogatory stimulus is related to a stimulus applied to the associated segment.

7. The apparatus of claim 1, wherein the plurality of stimuli are applied using a permanent adhesive, a reusable adhesive, or a combination of both.

8. The apparatus of claim 1, wherein the plurality of stimuli are applied using a printing process.

9. The apparatus of claim 1, wherein the plurality of stimuli are applied using an embossing process.

10. The apparatus of claim 1, wherein the plurality of stimuli are applied using an erasable printing process.

11. The apparatus of claim 6, wherein the interrogatory stimulus is one of a question, a picture, or a combination of both.

12. The apparatus of claim 1, wherein the three-dimensional object is a size between about 2.0 feet to about 4.0 feet.

13. The apparatus of claim 1, wherein the three-dimensional object is a size between about 4.0 inches to about 6.0 inches in diameter

14. A method, comprising:
providing a three-dimensional object, wherein the three-dimensional object comprises a plurality of segments and a plurality of stimuli, wherein at least one stimulus is applied to at least one segment;
transferring the three-dimensional object between a plurality of persons, wherein at least one person of the plurality stops transferring at a specific moment;
holding the three-dimensional object; and
responding to the at least one stimulus.

15. The method of claim 14, further comprising coinciding the specific moment with an audible command.

16. The method of claim 14, further comprising coinciding the specific moment with a visual command.

17. The method of claim 14, further comprising:
running a timing device during the transferring of the three-dimensional object; and
coinciding the specific moment with a halting of the timing device.

18. The method of claim 14, further comprising:
playing music during the transferring of the three-dimensional object between a plurality of persons; and
coinciding the specific moment with a break in the music.

19. The method of claim 14, wherein the at least one stimulus is placed in a predetermined position relative to a holder of the three-dimensional object.

20. The method of claim 19, wherein the predetermined position of the at least one stimulus is beneath a thumb of the holder.

21. The method of claim 19, wherein the predetermined position of the at least one stimulus is beneath a finger of the holder.

22. The method of claim 14, wherein transferring the three-dimensional object is one of passing, tossing, rolling, kicking, and any combination thereof.

23. The method of claim 14, wherein responding to the at least one stimulus further comprises articulating the at least one stimulus.

24. The method of claim 14, wherein responding to the at least one stimulus further comprises performing an action related to the at least one stimulus

25. The method of claim 14, wherein responding to the at least one stimulus further comprises answering an interrogatory related to the at least one stimulus.

26. The method of claim 14, wherein the plurality of stimuli further comprises at least one of a word, letter, action, name, question, picture, color, number, shape, commercial brand name, menu item, and any combination thereof.

27. The apparatus of claim 14, wherein the three-dimensional object is one of a sphere, a cube, a pyramid, a polyhedron, an icosahedron, and a truncated icosahedron.

28. The apparatus of claim 14, further comprising:
removing the least one stimulus from at least one segment; and
replacing the at least one stimulus with a different stimulus.

29. A computer-readable memory storing computer code for implementing a method, the code comprising:
code for providing a virtual three-dimensional object, wherein the virtual three-dimensional object comprises a plurality of segments and a plurality of stimuli, wherein at least one stimulus is applied to at least one segment;
code for setting the virtual three-dimensional object into motion;
code for halting the virtual three-dimensional object; and
code for receiving a response to the at least one stimulus.

30. The computer-readable memory storing computer code of claim 29, further comprising code for to prompt a response to the at least one stimulus.

31. The computer-readable memory storing computer code of claim 29, further comprising code to interact with multiple users.
